(19) United States
(12) Patent Application Publication
(10) Pub. No.: US 2017/0301129 A1
(43) Pub. Date: Oct. 19, 2017

(54) MEDICAL IMAGE PROCESSING APPARATUS, MEDICAL IMAGE PROCESSING METHOD, AND MEDICAL IMAGE PROCESSING SYSTEM

(71) Applicant: ZIOSOFT, INC., Tokyo (JP)

(72) Inventors: Shinichiro SEO, Tokyo (JP); Yuichiro HOURAI, Tokyo (JP)

(21) Appl. No.: 15/485,746

(22) Filed: Apr. 12, 2017

(30) Foreign Application Priority Data
Apr. 14, 2016 (JP) 2016-081345

(51) Int. Cl. G06T 15/08; G06T 7/11; G06T 7/00; G06K 9/52; G06T 5/00

(52) U.S. Cl. CPC G06T 15/08; G06K 9/52; G06T 5/008; G06T 7/0012; G06T 7/11; G06T 2207/10088; G06T 2207/10104; G06T 2211/404; G06T 2207/10081

(57) ABSTRACT

A medical image processing apparatus includes a port, a processor and a display. The port acquires volume data including a subject. The processor generates an image based on the volume data. The display shows the generated image. A pixel value of at least one pixel of the image is defined based on (i) a statistical value of voxel values of voxels in a predetermined range on a virtual ray projected to the volume data and (ii) shading of a contour of the subject at a predetermined position on the virtual ray.

### CROSS-REFERENCE TO RELATED APPLICATION

This application claims priority based on Japanese Patent Application No. 2016-081345, filed on Apr. 14, 2016, the entire contents of which are incorporated by reference herein.

### BACKGROUND OF THE INVENTION

### 1. Field of the Invention

The present disclosure relates to a medical image processing apparatus, a medical image processing method, and a medical image processing system.

### 2. Related Art

In the related art, a raycast method is known as one of the volume rendering methods. The following medical image processing apparatus is known as a medical image processing apparatus that generates a medical image in accordance with the raycast method.

The medical image processing apparatus generates a 3-dimensional image indicating an intestine inner wall surface by acquiring voxel data obtained by imaging the internal portion of an organism using a modality. The 3-dimensional imaging is performed by volume rendering using the raycast method. At this time, the medical image processing apparatus generates a 3-dimensional medical image which can distinguishably display an abnormal part invasively manifested inside an intestine inner wall while maintaining a clear shading of the intestine inner wall surface by using color information corresponding to the voxel data at a position shifted by a predetermined distance from the intestine inner wall (see U.S. Pat. No. 7,639,867 B).

### SUMMARY OF THE INVENTION

The medical image processing apparatus in U.S. Pat. No. 7,639,867 may overlook a disease such that, in a raycast image generated in accordance with the raycast method, the generated image is not intuitive and the disease is regarded to be distant from a deviated position.

The present disclosure is finalized in view of the foregoing circumstance and provides a medical image processing apparatus, a medical image processing method, and a medical image processing program capable of improving visibility of both an internal state of a subject and an external shape of the subject.

A medical image processing apparatus of the present disclosure includes a port, a processor and a display. The port acquires volume data including a subject. The processor generates an image based on the volume data. The display shows the generated image. A pixel value of at least one pixel of the image is defined based on (i) a statistical value of voxel values of voxels in a predetermined range on a virtual ray projected to the volume data and (ii) shading of a contour of the subject at a predetermined position on the virtual ray.

A medical image processing method in a medical image processing apparatus of the present disclosure, includes: acquiring volume data including a subject; generating an image based on the volume data; and displaying the generated image. A pixel value of at least one pixel of the image is defined based on (i) a statistical value of voxel values of voxels in a predetermined range on a virtual ray projected to the volume data and (ii) shading of a contour of the subject at a predetermined position on the virtual ray.

A medical image processing system of the present disclosure, causes a medical image processing apparatus to execute operations including: acquiring volume data including a subject; generating an image based on the volume data: and displaying the generated image. A pixel value of at least one pixel of the image is defined based on (i) a statistical value of voxel values of voxels in a predetermined range on a virtual ray projected to the volume data and (ii) shading of a contour of the subject at a predetermined position on the virtual ray.

According to the present disclosure, it is possible to improve visibility of both an internal state of a subject and an external shape of the subject.

### BRIEF DESCRIPTION OF THE INVENTION

The patent or application file contains at least one drawing executed in color. Copies of this patent or patent application publication with color drawing(s) will be provided by the Office upon request and payment of the necessary fee.

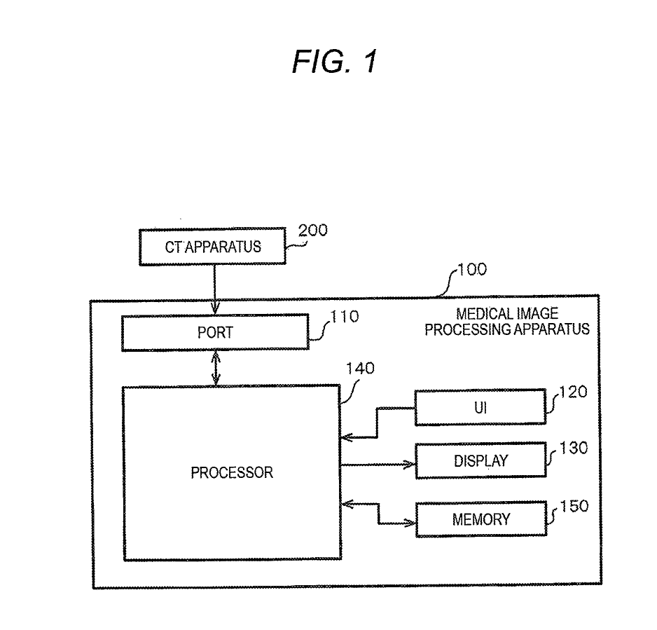

FIG. 1 is a block diagram illustrating a configuration example of a medical image processing apparatus according to a first embodiment;

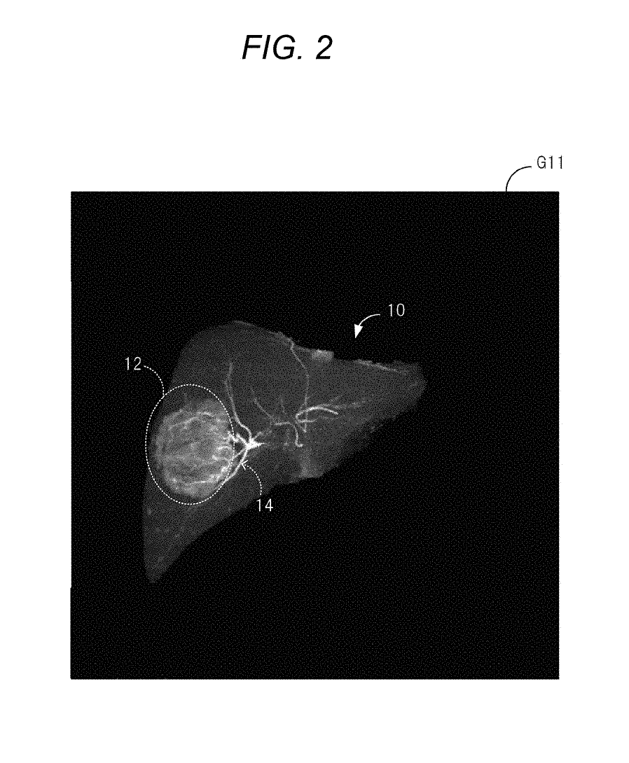

FIG. 2 is a schematic diagram illustrating a display example of an MIP image visualizing the internal portion of a tissue or the like;

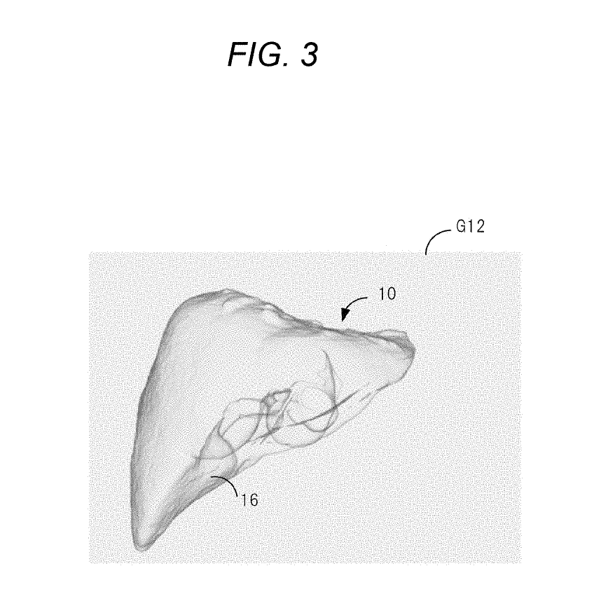

FIG. 3 is a schematic diagram illustrating a display example of a shading image visualizing the contour of a tissue or the like;

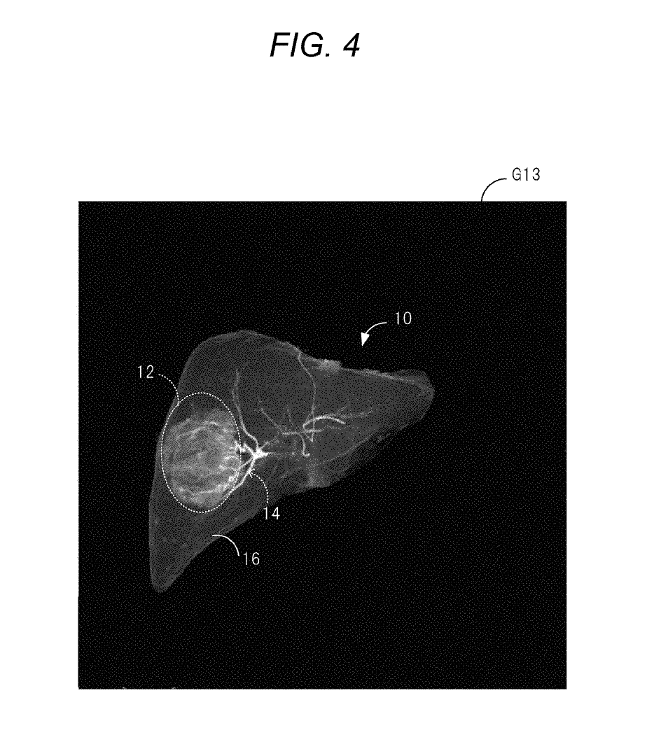

FIG. 4 is a schematic diagram illustrating a first display example of a synthetic image of the MIP image and the shading image;

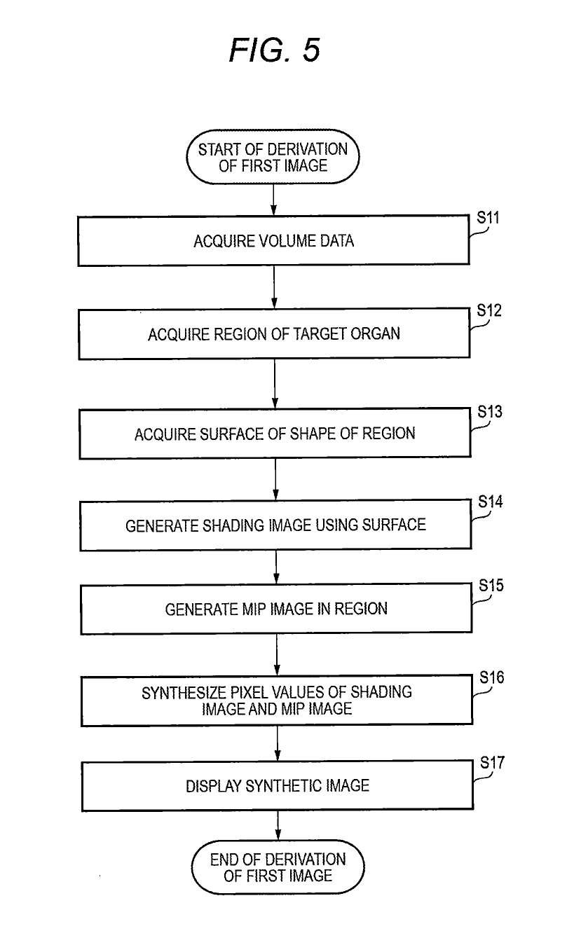

FIG. 5 is a flowchart illustrating a first operation example when an image is derived by the medical image processing apparatus;

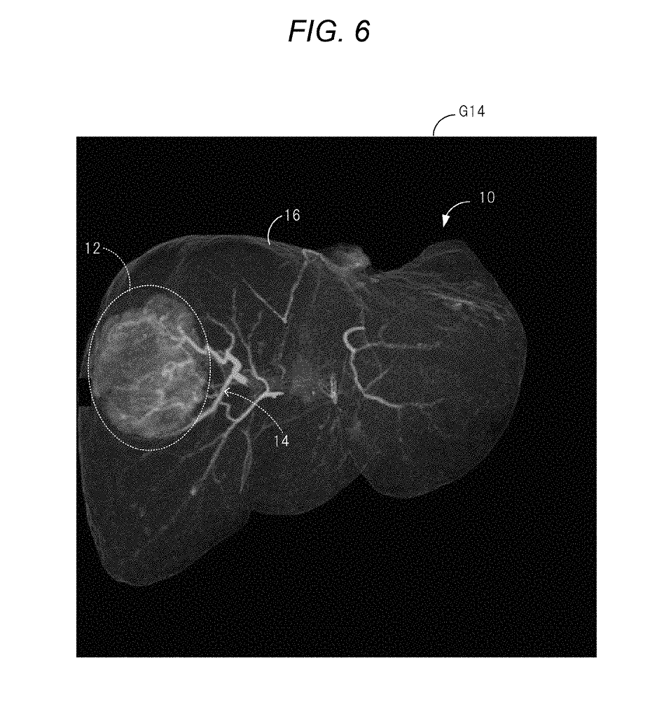

FIG. 6 is a schematic diagram illustrating a second display example of the synthetic image of the MIP image and the shading image;

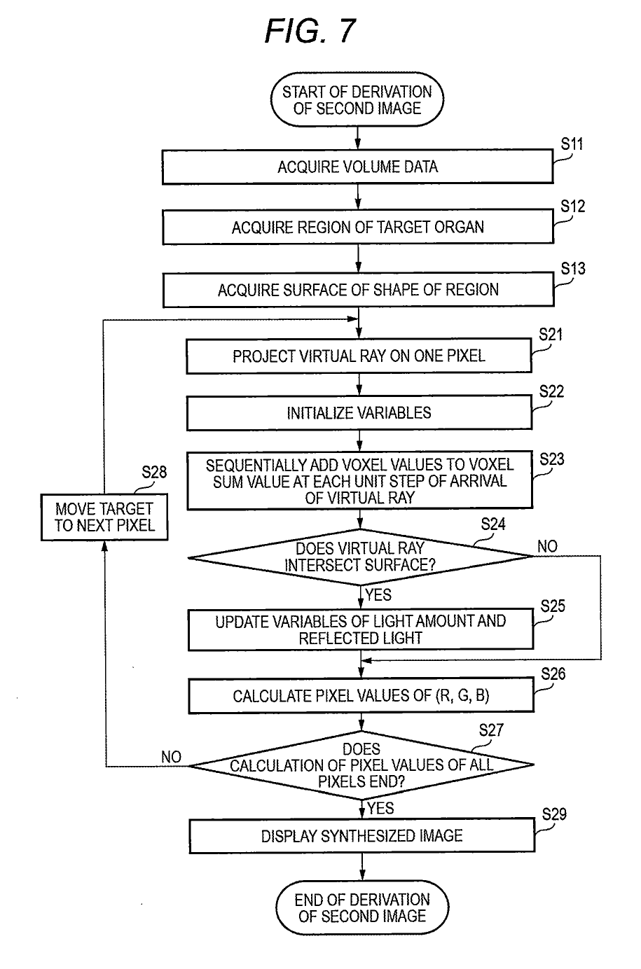

FIG. 7 is a flowchart illustrating a second operation example when an image is derived by the medical image processing apparatus;

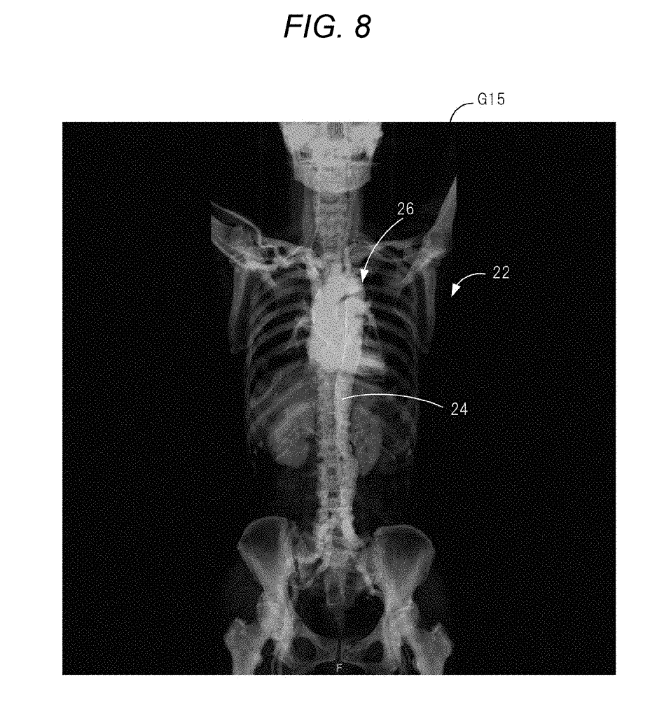

FIG. 8 is a schematic diagram illustrating a display example of a synthetic image of an SUM image and a shading image; and

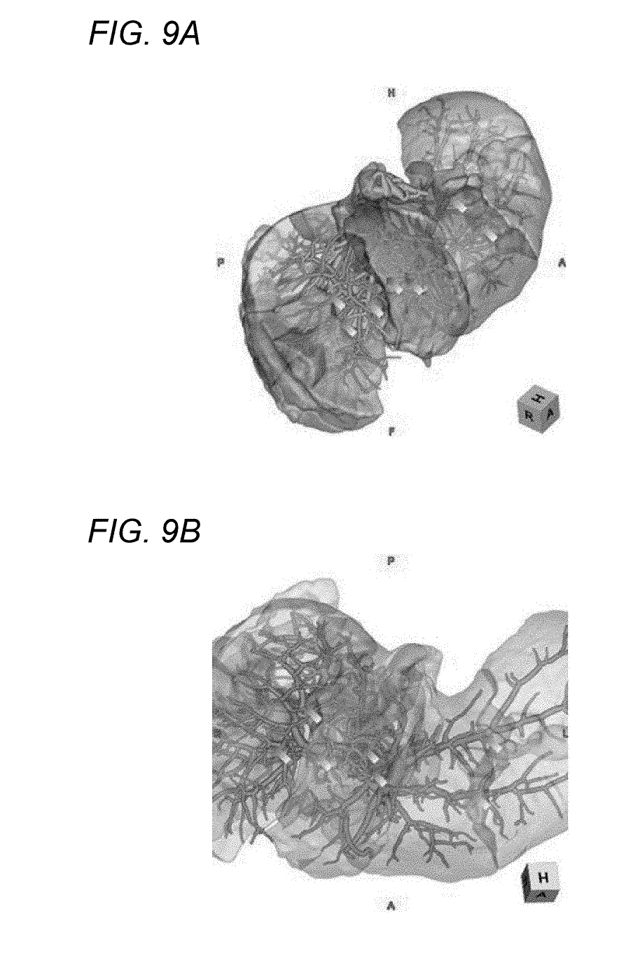

FIGS. 9A and 9B are schematic diagrams illustrating surface rendering images subjected to translucent rendering.

### DETAILED DESCRIPTION OF THE INVENTION

Hereinafter, embodiments of the present disclosure will be described with reference to the drawings.

In the present invention, a medical image processing apparatus of the present disclosure includes a port, a processor and a display. The port acquires volume data including a subject. The processor generates an image based on the volume data. The display shows the generated image. Based on the acquired volume data, the processor generates the image such that a pixel value of at least one pixel of the image is defined based on (i) a statistical value of voxel values of voxels in a predetermined range on a virtual ray projected to the volume data and (ii) shading of a contour of the subject at a predetermined position on the virtual ray, to display the generated image on the display.

### (Background to Achievement of Embodiments of the Present Disclosure)

A medical image can be generated as a 3-dimensional image in accordance with each rendering method on volume data, but it is difficult to express both the internal state of a tissue and the contour of the tissue with good visibility.

For example, for a MIP image generated in accordance with a maximum intensity projection (MIP) method, the contour of the tissue is not well visualized. In addition, it is difficult to express sense of depth of the MIP image.

On the other hand, raycast image is not appropriate to express an internal shape of the tissue because the front surface of a tissue is rendered. In a raycast image, one may lower voxel opacity, in which to express a tissue with a vague contour as is rather than expressing the internal portion of the tissue.

In a surface rendering image in which a surface of a tissue is used, it is difficult to extract the surface with a minute shape of a tissue (for example, a peripheral-vascular). Thus, a tissue is intermittently expressed in many cases. For example, when a tube is gradually thinned and a pixel value decreases, it is difficult to generate the surface. When adaptive thresholding is done in surface extraction, objectivity is not sufficiently ensured. When the thickness of the tube is less than 1 voxel, an appropriate surface cannot be decided.

When surface rendering is done with translucency rendering, the internal portion of a tissue can be visualized. However, the internal portion of a tissue (for example, a peripheral vascular) or a tumor is visualized arbitrarily in some cases (see FIGS. 9A and 9B). Since a boundary of the internal portion of a tissue or a tumor is not clear, it is difficult to generate a surface. When many translucent surfaces overlapped on a same pixel, a value of the pixel decreases, and then clear visualization is more difficult.

Hereinafter, a medical image processing apparatus, a medical image processing method, and a medical image processing program capable of improving visibility of both an internal state of a subject and an external shape of the subject will be described.

### First Embodiment

In the embodiment, a “tissue or the like” includes an organ such as a bone or a blood vessel, a part of an organ such as a lobe of the lung or a ventricle, or a disease tissue such a tumor or a cyst. The tissue or the like includes a combination of a gallbladder and a liver and a combination of a plurality of organs such as right and left lungs.

FIG. 1 is a block diagram illustrating a configuration example of a medical image processing apparatus 100 according to a first embodiment. The medical image processing apparatus 100 includes a port 110, a user interface (UI) 120, a display 130, a processor 140, and a memory 150.

A CT apparatus 200 is connected to the medical image processing apparatus 100. The medical image processing apparatus 100 acquires volume data from the CT apparatus 200 and performs a process on the acquired volume data. The medical image processing apparatus 100 may be configured to include a personal computer (PC) and software mounted on the PC. The medical image processing apparatus 100 may be provided as an attachment apparatus of the CT apparatus 200.

The CT apparatus 200 irradiates an organism with an X ray and acquires an image (CT image) using a difference in absorption of the X ray by a tissue in a body. A human body is exemplified as the organism. The organism is an example of a subject.

The plurality of CT images may be acquired in a time series. The CT apparatus 200 generates volume data including information regarding any portion inside the organism. Here, any portion inside the organism may include various organs (for example, a heart and a kidney). By acquiring the CT image, it is possible to obtain a CT value of each pixel (voxel) of the CT image. The CT apparatus 200 transmits the volume data as the CT image to the medical image processing apparatus 100 via a wired circuit or a wireless circuit.

The CT apparatus 200 can also acquire a plurality of piece of 3-dimensional volume data by continuously performing capturing and generate a moving image. Data of the moving image formed by the plurality of 3-dimensional images is also referred to as 4-dimensional (4D) data.

The port 110 in the medical image processing apparatus 100 includes a communication port or an external apparatus connection port and acquires volume data obtained from the CT image. The acquired volume data may be transmitted directly to the processor 140 to be processed variously or may be stored in the memory 150 and subsequently transmitted to the processor 140 to be processed variously, as necessary.

The UI 120 may include a touch panel, a pointing device, a keyboard, or a microphone. The UI 120 receives any input operation from a user of the medical image processing apparatus 100. The user may include a medical doctor, a radiologist, or another medical staff (paramedic staff).

The UI 120 receives an operation of designating a region of interest (ROI) in the volume data or setting a luminance condition. The ROI may include a region of a disease or a tissue (for example, a blood vessel, an organ, or a bone).

The display 130 may include a liquid crystal display (LCD) and display various kinds of information. The various kinds of information include 3-dimensional images obtained from the volume data. The 3-dimensional image may include a volume rendering image, a surface rendering image, and a multi-planar reconstruction (MPR) image.

The memory 150 includes a primary storage device such as various read-only memories (ROMs) or random access memories (RAMs). The memory 150 may include a secondary storage device such as a hard disk drive (HDD) or a solid state drive (SSD). The memory 150 stores various kinds of information or programs. The various kinds of information may include volume data acquired by the port 10, an image generated by the processor 140, and setting information set by the processor 140.

The processor 140 may include a central processing unit (CPU), a digital signal processor (DSP), or a graphics processing unit (GPU).

The processor 140 performs various processes or controls by executing a medical image processing program stored in the memory 150. The processor 140 generally controls the units of the medical image processing apparatus 100.

The processor 140 may perform a segmentation process on the volume data. In this case, the UI 120 receives an instruction from the user and the information of the instruction is transmitted to the processor 140. The processor 140 may perform the segmentation process to extract (segment) a ROI from the volume data in accordance with a known method based on the information of the instruction. A ROI may be manually set in response to a detailed instruction from the user. When an observation target tissue or the like is decided in advance, the processor 140 may perform the segmentation process from the volume data and extract the ROI including the observation target tissue or the like without an instruction from the user.

The processor 140 generates a 3-dimensional image based on the volume data acquired by the port 110. The processor 140 may generate a 3-dimensional image based on a designated region from the volume data acquired by the port 110.

When the 3-dimensional image is a volume rendering image, an SUM image, a maximum intensity projection (MIP) image, a minimum intensity projection (MinIP) image, an average value image, or a raycast image may be included. The SUM image is also referred to as a RaySUM image and a sum value of voxel values of voxels on a virtual ray is indicated as a projection value (pixel value) of a projection surface.

In the embodiment, a raycast image is not assumed as a volume rendering image for expressing an internal portion of a tissue or the like. A raycast image can be assumed as a volume rendering image for expressing shade of a tissue or the like.

Next, an operation of the medical image processing apparatus 100 will be described.

First, an overview of the operation of the medical image processing apparatus 100 will be described.

In a volume rendering method, by projecting a virtual ray from a virtual starting point to 3-dimensional voxels that form volume data, an image is projected to a projection surface and the volume data is visualized.

The processor 140 performs calculation related to volume rendering (for example, MIP or SUM) in the entire volume data or a ROI using the virtual ray. An image (volume rendering image) generated through the volume rendering is used to express an internal portion of a tissue or the like. Therefore, this image is also referred to as an “internal image.” Information (for example, a pixel value) regarding the volume rendering used to express an internal portion of a tissue or the like is also referred to as “internal information.”

The processor 140 calculates shading on boundary surface of the entire volume data or a ROI. For the shading, the boundary of the entire volume data or the ROI is extracted as a surface and the shading of the surface is added through surface rendering.

An image (surface rendering image) generated through the surface rendering is used to express shade of a contour as an external shape of a tissue or the like. Therefore, this image is also referred to as a “shading image.” Information (for example, a pixel value) regarding surface rendering used to express the shade of a tissue or the like is also referred to as “shading information.”

The processor 140 combines the internal information and the shading information of the entire volume data or the ROI. The display 130 displays an image (display image) obtained by combining the information.

Thus, the medical image processing apparatus 100 can make it possible to easily ascertain a positional relation in a tissue or the like between high-luminance parts within the tissue or the like. The medical image processing apparatus 100 can make it possible to easily ascertain the external shape of a tissue or the like by the display of the shade.

FIGS. 2 to 4 are schematic diagrams illustrating images obtained by the medical image processing apparatus 100. FIG. 2 illustrates an MIP image G11 as an internal image of a ROI. FIG. 3 illustrates a shading image G12 of the ROI. FIG. 4 illustrates a synthetic image of FIGS. 2 and 3, that is, a synthetic image G13 of the IMP image G11 and the shading image G12.

In FIGS. 2 to 4, a liver 10 is illustrated as a ROI. The medical image processing apparatus 100 can visualize a tumor 12 contained in the liver 10 or a blood vessel 14 inside the liver 10 along with shade 16 indicating the contour and lobe of the liver 10 by generating the synthetic image G13. In FIG. 4, the tumor 12 and the blood vessel 14 in the liver 10, and the shapes of the liver 10 itself, the structure of lobes, and the like are visualized.

The processor 140 generates a surface rendering image based on parameters. The parameters used for the surface rendering can include a color of the surface, a color of light, an angle of the light, and an ambient light. The color of the light indicates a color of a virtual ray projected to the volume data. The angle of the light indicates an angle (shading angle) formed between a ray direction (a traveling direction of the virtual ray) and a surface normal (a normal line at a point intersecting the virtual ray with respect to the surface). The ambient light indicates light in an environment in which the volume data is put and is light spreading in the entire space.

The processor 140 performs, for example, surface rendering based on information regarding an angle of light among the parameters. Thus, shading information is obtained from shading angle on the surface. Accordingly, the processor 140 can acquire the shade of the contour in regard to a part (for example, a ROI) of the volume data or the entire volume data through the surface rendering based on the shading angle.

When the surface rendering is performed based on the shading angle, for example, when the surface normal becomes parallel to the ray direction, it is difficult to add shade and the shade is thinned. The fact that the surface normal is parallel to the ray direction can say that the shading angle is small. When the surface normal becomes vertical to the ray direction, shade is easily added and the shade becomes darker. The fact that the surface normal is vertical to the ray direction can say that the shading angle is large. When the shade is lighter (that is, the shading angle is smaller) and the opacity is set to be lowered, an image of which a contour is clearer can be obtained.

Next, a detailed operation of the medical image processing apparatus 100 will be described.

FIG. 5 is a flowchart illustrating a first operation example when an image is derived by the medical image processing apparatus 100. In the first operation example, the case in which one ROI is set, an internal image indicating the internal portion of the ROI and a shading image indicating the contour of the ROI are derived, and the internal image and the shading image are synthesize to derive a synthetic image is exemplified.

First, the processor 140 acquires volume data transmitted from the CT apparatus 200 (S11).

The processor 140 sets a region of a tissue or the like (target organ) within the volume data through a known segmentation process (S12). In this case, for example, after a user roughly designates and extracts a region via the UI 120, the processor 140 may accurately extract the region. In S12, the region of the liver 10 may be designated as a ROI.

The processor 140 derives a surface indicating contour of the region of a tissue or the like from the volume data (S13). In this case, the processor 140 generates polygon mesh from the voxel data of the volume data in accordance with, for example, a marching cube method and acquires a surface of the tissue or the like from the polygon mesh. The medical image processing apparatus 100 can acquire a smooth contour of the tissue or the like by deriving the surface.

The processor 140 generates a shading image through a shading process on the surface (S14). The shading process indicates a process by which a photographing effect can be obtained by changing the color information according to the shading angle and a distance from a virtual light source projecting a virtual ray at a target point on the surface. Points present on the surface are selected in order as target points of the surface.

The processor 140 sets opacity of the shade according to the shading angle in the shading process. For example, when the virtual ray is vertically projected to the target points of the surface, that is, the surface normal is parallel to the virtual ray, the processor 140 transparently sets the shade (that is, sets the opacity of the shade to a low value). When the virtual ray is projected to the target points of the surface in parallel, that is, the surface normal is vertical to the virtual ray, the processor 140 opaquely sets the shade (that is, sets the opacity of the shade to a high value). The generated shading image is illustrated in FIG. 3 described above.

The processor 140 generates an MIP image from the volume data of the region of the tissue or the like (S15). That is, the processor 140 projects the virtual ray for each pixel of the projection surface in regard to the volume data and obtains a voxel value. The processor 140 calculates a maximum value of the voxel values on the same virtual ray as a projection value for each pixel of the MIP image. The MIP image is illustrated in FIG. 2 described above.

The processor 140 combines the generated MIP image with the shading image to generate a synthetic image (S16). That is, the processor 140 combines the pixel values of the MIP image and the shading image. Here, the processor 140 obtains color information (for example, pixel values of RGB) in the synthetic image based on the pixel values of the MIP image and the shading image. The processor 140 combines the MIP image and the shading image by mapping the color information of the obtained pixels on the projection surface to generate the synthetic image.

When the pixel values of the synthetic image are expressed with RGB, a pixel value “R” of an R channel, a pixel value “G” of a G channel, and a pixel value “B” of a B channel are represented as follows:

R=MAX (a pixel value of the MIP image or a pixel value of the shading image);

G=a pixel value of the MIP image; and

B=a pixel value of the MIP image.

The pixel values of the MIP image are included in components “R,” “G,” and “B,” and thus the MIP image is expressed as a monochromic image. The pixel values of the shaped image are included in the component “R,” and thus the shading image is expressed as a red image. A display example of the synthetic image in which the MIP image is visualized with black and white and the shading image is visualized with red is illustrated in FIG. 4 described above.

MAX(A, B) indicates a maximum value combination of A and B. That is, maximum pixel values at the time of combining the MIP image and the shading image are defined. Thus, when the pixel values of the MIP image are large, the pixel values of the shading image decrease according to the pixel values of the MIP image.

The display 130 displays the synthetic image generated in S16 (S17).

In the first operation example illustrated in FIG. 5, the medical image processing apparatus 100 derives the contour of the tissue or the like and the internal portion of the tissue or the like using the same ROI. Then, the medical image processing apparatus 100 can synthesize and display the red shading image indicating the contour of the tissue or the like and the monochromic MIP image indicating the internal portion of the tissue or the like. Accordingly, the user can clearly recognize the contour, and thus obtain sense of depth or sense of bumps.

The medical image processing apparatus 100 can mainly express the internal portion of the tissue or the like using the MIP image in a portion in which the pixel values of the MIP image are large and the MIP image is dominant by combining the maximum values of the MIP image and the shading image. The medical image processing apparatus 100 can mainly express the shade of the contour of the tissue or the like in a portion in which the pixel values of the MIP image are small and the shading image is dominant. Accordingly, the medical image processing apparatus 100 can prevent appearance of the shade in which fine priority is low.

In accordance with a different method from S17, the pixel values (color information of RGB) of the synthetic image may be obtained. The pixel values of the RGB may be represented as follows:

R=a pixel value of the shading image;

G=a pixel value of the MIP image; and

B=a pixel value of the MIP image.

That is, when the pixel values of the synthetic image are expressed with RGB, the processor 140 may map the R channel of RGB from a pixel value of the shading image, map the G channel of RGB from a pixel value of the MIP image, and map the B channel of RGB from a pixel value of the MIP image. This calculation is performed for each pixel of the projection surface, that is, each pixel of the synthetic image.

The pixel values of the MIP image are included in the components “O” and “B,” and thus the MIP image is expressed as an image of light blue. The pixel values of the shading image are included in the component “R,” and thus the shading image is expressed as a red image. A display example of the synthetic image G14 in which the MIP image is visualized with light blue and the shading image is visualized with red is illustrated in FIG. 6.

By not including the color component (here, the component “R”) of the shading image in the color information of the MIP image as in FIG. 6, the medical image processing apparatus 100 can avoid absence of the color information at the time of image fusion of the MIP image and the shading image, and thus can visualize the shade more clearly. That is, in FIG. 6, the red component of the MIP image can be clipped due to the maximum value fusion and a part of the information of the red component can be prevented from lacking, compared to the case of FIG. 4. Accordingly, the medical image processing apparatus 100 can prevent the quality of the shading image from deteriorating and can make it possible to easily ascertain the internal portion and the external shape of a tissue or the like.

Although not illustrated, the processor 140 may prepare two MIP images, indicate a first MIP image with the “R” and “G” components, indicate a second MIP image with the “B” component, and indicate the shading image with the “R” component. By using the two MIP images, the medical image processing apparatus 100 can visualize the MIP image more clearly so that the internal portion of the tissue or the like can be more easily observed.

FIG. 7 is a flowchart illustrating a second operation example when an image is derived by the medical image processing apparatus 100. In the second operation example, the case in which, one ROI is set, internal information (information regarding the SUM image) indicating the internal portion of the ROI and shading information indicating the contour of the ROI are derived, and a synthetic image is derived based on combination information obtained by combining the internal information and the shading information is exemplified.

First, the processor 140 performs processes of S11 to S13 of FIG. 5. Here, in S12, a region of a main artery may be designated as a ROI.

The processor 140 projects a virtual ray to calculate each pixel on the projection surface (S21). The virtual ray travels to reach an end portion of the region set in S12 and travels even after the virtual ray intersects the surface. One virtual ray is projected, for example, for each pixel of the projection surface (for each pixel of a display image).

The processor 140 initializes each variable (S22). The variables include, for example, parameters of a voxel sum value, the amount of a virtual ray, and a reflected ray of the virtual ray reflected from the surface. Here, the processor 140 initially sets the voxel sum value to 0, initially sets the ray amount to 1, and initially sets the reflected ray to 0.

The processor 140 causes an arrival position of the virtual ray on the volume data for each unit step (for example, for each voxel) to advance. That is, the arrival position of the virtual ray advances at intervals of the same distance. The processor 140 adds the voxel value at the arrival position of the virtual ray to the voxel sum value (S23). The addition of the voxel sum value is also performed at a point at which the virtual ray intersects the surface.

When the virtual ray interests the surface (Yes in S24), that is, the arrival position of the virtual ray is on the surface, the processor 140 updates the values of the my amount and the reflected light (S25). The processor 140 derives values of a new ray amount and a new reflected ray in accordance with (Equation 1) and (Equation 2) below, for example. These values can be retained in the memory 150.

New ray amount=current ray amount*(1−(ray direction)·(surface normal)) (Equation 1)

New reflected ray=current reflected ray+current ray amount*(1−(ray direction)·(surface normal)) (Equation 2)

Here, asterisk “*” indicates a multiplication sign. Further, “·” indicates an inner product sign. The ray direction indicates a traveling direction of the virtual ray. The surface normal indicates a normal line direction to the surface at a point on the surface corresponding to a pixel. That is, a shading angle is derived based on the ray direction and the surface normal.

A point intersecting the surface on the virtual ray may not be present at any pixel on the projection surface, one point may be present, or two or more points may be present.

When the pixel value of a target pixel is expressed with RGB, when (R, G, and B) are assumed to be a pixel value “R” of the R channel, a pixel value “G” of the G channel, and a pixel value “B” of the B channel, the processor 140 derives the pixel values of the R, 0, and B channels in accordance with, for example, the following (Equation 3) (S26).

(R,G,B)=(1,0,0)*new reflected ray+(0,1,1)*WW/WL transformation function(voxel sum value) (Equation 3)

The WW (Window Width)/WL (Window Level) transformation function is a known function for luminance adjustment when an image is displayed by the display 130. One WW/WL transformation function is decided for an entire image and is common to pixels in the image. Typically, the WW/WL transformation function (voxel sum value) indicates that the voxel sum value is given as an argument to the WW/WL transformation function.

The voxel sum value derived in S23 is a relatively large value as a value for the display. Therefore, the processor 140 transforms the voxel sum value into a value appropriate for the display by calculating the WW/WL transformation function (voxel sum value). The processor 140 clips the pixel value of each of the R, G, and B channels exceeding 1 and sets the pixel value to 1.

In (Equation 3), the pixel values of the SUM image are included in the “G” and “B” components, and thus the SUM image is expressed as an image of light blue. The pixel value of the shading image is included in the “R” component, and thus the shading image is expressed as a red image. A display example of the synthetic image in which the SUM image is visualized with light blue and the shading image is visualized with red is illustrated in FIG. 8.

When the processes of S21 to S26 on the target pixels are completed, the processor 140 determines whether the processes of S21 to S26 on all the pixels are completed (527). When the processes on all the pixels do not end, a subsequent pixel is set as a target pixel (S28), and the processes of S21 to S26 are performed. Thus, the processor 140 derives the pixel values of (R, G, B) from the pixels and generates a synthetic image with the pixel values.

The display 130 displays the generated synthetic image (S29).

FIG. 8 is a schematic diagram illustrating a display example of a synthetic image G15 of an SUM image and a shading image. Since a human body 22 which is a subject facing in front of a display screen (projection surface) in FIG. 8, red pixel values related to the shading image are decreased. When the human body is rotated about a body axis, a relation between the ray direction and the surface normal is changed, the shading angle is changed, and the red shade is further emphasized and displayed in some cases.

In FIG. 8, a main artery 24 is set as a ROI. Therefore, red shade 26 is displayed along the contour of the main artery 24 which is the ROI. The user can easily ascertain sense of depth or the contour of the main artery 24 which is an observation target by following and viewing the red shade 26.

FIG. 8 illustrates an example of mapping of the color information in the second operation example. As in the first operation example, a synthetic image may be generated according to different color information from the color information in FIG. 8.

In the second operation example illustrated in FIG. 7, the medical image processing apparatus 100 derives the contour of a tissue or the like and the internal portion of the tissue or the like using a different ROI. In FIG. 8, the contour of the tissue or the like is derived in a region of the entire volume data and the internal portion of the tissue or the like is derived in a region of a main artery. The medical image processing apparatus 100 synthesizes and displays the red shading image indicating the contour of the tissue or the like and the MIP image of light blue indicating the internal portion of the tissue or the like. Accordingly, the user can clearly recognize the contour of a specific tissue or the like present in the volume data, and thus can obtain sense of depth or sense of bumps of the specific tissue or the like to make a comparison with the entire volume data.

In the first and second operation examples, the case in which one ROI is set is exemplified, but two or more regions of interest may be set. For example, the processor 140 may set a region in which bones are removed from entire upper limb as one ROI and may set the main artery as another ROI via the UI 120.

Thus, for example, the medical image processing apparatus 100 can synthesize and display the red shading image indicting the contour of the main artery and the MIP image of light blue indicating the internal portion of the upper limb. Accordingly, the user can clearly recognize the contour of another second region present in an internal portion of a first region of the subject, and thus can obtain sense of depth or sense of bumps of the tissue or the like present in the second region to make a comparison with the first region. The user can ascertain an accurate positional relation of a disease visualized in the first region, depending on sense of depth or sense of bumps of the tissue or the like present in the second region of the subject.

In this way, the medical image processing apparatus 100 can generate a synthetic image using the volume rendering by which a vague state is visualized and the surface rendering by which the contour is clearly expressed. When the medical image processing apparatus 100 displays the synthetic image, the user can observe that there is the tumor 12 and blood flows toward the tumor 12, for example, as illustrated in FIG. 4. By adding shade to the contour of the liver 10, it is possible to ascertain sense of bumps, that is, the external shape of the liver 10.

The medical image processing apparatus 100 can make it possible to easily confirm both the internal portion and the external shape of the tissue or the like using both rendering by which shade is normally not added (for example, volume rendering by MIP) and rendering by which shade is normally added (for example, raycast and surface rendering).

In a region indicating the internal portion of the tissue or the like and a region indicating the shade of the contour of the tissue or the like, unlike U.S. Pat. No. 7,639,867 B, parameters independent from a parameter (for example, a current ray amount) related to ray attenuation and a parameter (for example, a voxel sum value) for calculating a statistical value can be used. In this case, parameters related to a shading process do not affect the volume rendering of expressing the internal portion of the tissue or the like. Accordingly, the medical image processing apparatus 100 can make it possible to confirm the state of the internal portion of the tissue or the like and the external shape of the tissue or the like as independent information.

### Other Embodiments

The embodiments have been described above with reference to the drawings, but it is regardless to say that the present disclosure is not limited to the examples. It should be apparent to those skilled in the an that various modification examples or correction examples can be made within the scope described in the claims and it is understood that the modification examples and the correction examples also, of course, pertain to the technical scope of the present disclosure.

In the foregoing embodiment, for example, the image (the MIP image or the SUM image) of the internal portion of a tissue or the like is expressed with black and white or light blue, but may be expressed with other color. For example, the shading image (surface rendering image) of a tissue or the like is expressed with red, but may be expressed with other colors.

In the foregoing embodiment, the case in which two IMP images and one shading image are combined as an example of the synthetic image is exemplified. In this case, the processor 140 can perform calculation using, for example, (Equation 4). Here, the processor 140 may generalize the first MIP image, the second MIP image, and the shading image as three images on the virtual ray, perform transformation, and then set channels of RGB of the pixel values of the synthetic image. In (Equation 4), pixel values after transformation (values of R, G, and B in ( )) are obtained by multiplying pixel values (ch1 to ch3 in (Equation 4)) obtained at the time of generating three images by a transformation matrix T (a 3×3 matrix in (Equation 4)). The color information includes values of “R,” “G,” and “B.”

$$\begin{matrix}[ Math . 1 ] & \\ ( \begin{matrix}R \\ G \\ B\end{matrix} ) = ( \begin{matrix}1 & 0 & 0 \\ 0.1 & 0.4 & 0.5 \\ 0 & 0.2 & 0.8\end{matrix} ) ( \begin{matrix}ch 1 \\ ch 2 \\ ch 3\end{matrix} ) & ( Equation 4 )\end{matrix}$$

### (Equation 4)

“ch1” is a pixel value of the shading image obtained by the surface rendering or the like. “ch2” is a pixel value of the first MIP image obtained by the volume rendering or the like. “ch3” is a pixel value of the second MIP image obtained by the volume rendering or the like.

(Equation 4) is an equation for invertible transformation. Therefore, the processor 140 can calculate the values of R, G, and B using the transformation matrix T from the values of ch1, ch2, and ch3. The processor 140 can calculate the values of ch1, ch2, and ch3 using the transformation matrix T from the values of R, G, and B.

Since (Equation 4) is the equation for invertible transformation, the values of ch1, ch2, and ch3 and the values of R, G, and B can be mutually transformed. Accordingly, the shading image, the first MIP image and the second MIP image, and the synthetic image can be mutually transformed. The shading image, the first MIP image, and the second MIP image can be uniquely separated from the synthetic image. In particular, since the user can directly recall an image equivalent to the shading image, the first MIP image, and the second MIP image from the synthetic image, the user can easily ascertain a relation of the shapes of complicatedly overlapped regions (for example, a region of the internal portion of a tissue or the like and a region of the contour of the tissue or the like).

In this way, the processor 140 may project the virtual ray to the volume data and acquire projection information for each region (for each of the shading image, the first MIP image, and the second MIP image). The processor 140 may acquire color information based on the projection information and generate a synthetic image based on the color information. The processor 140 may perform invertible transformation on the projection information and acquire the color information of the synthetic image. The projection information includes a projection value.

In the foregoing embodiment, for example, one MIP image and one shading image are combined as an example of the synthetic image. In this case, the processor 140 may perform calculation using (Equation 5).

R=ch1

G=ch2

B=MAX(ch1,ch2) (Equation 5)

“ch1” is a pixel value of the shading image. “ch2” is a pixel value of the MIP image. (Equation 5) is used when two regions are designated, that is, one MIP image and one shading image are combined. (Equation 5) is an equation for invertible transformation like (Equation 4).

In the foregoing embodiment, for example, the processor 140 generates the synthetic image including the RGB components as the color information. Instead, the processor 140 may generate a synthetic image including HSV components as color information. The HSV components include a hue component, a saturation component, and a brightness component. The color information is not limited to the hue, but broadly includes information regarding color such as luminance or saturation. The processor 140 may use CMY components as color information.

In the foregoing embodiment, the processor 140 independently obtains the shading information and the internal information, but the shading information and the internal information may have an influence on each other. For example, the shading process may be performed using only a surface present in front (front surface side) of position (MIP position) at which a voxel value of a voxel on the same virtual ray obtained by projecting the virtual rays is maximum. Thus, the medical image processing apparatus 100 can clearly express shade of the surface present in front side on the virtual ray. The medical image processing apparatus 100 can prevent that shade becomes darkened and the pixel value decreases due to the shading process at positions within a plurality of surfaces on the virtual rays. The medical image processing apparatus 100 can emphasize the shading information near a portion particularly contributing to an image in the internal information.

In the foregoing embodiment, for example, the internal portion of a tissue or the like is mainly expressed with the MIP image or the SUM image, but may be expressed by other volume rendering images. The other images include, for example, a MinIP image and an AVE image. In the MinIP image, minimum signal values on a virtual ray are displayed. In the AVE image, average signal values on a virtual ray are displayed. In the foregoing embodiment, however, the volume rendering image does not include a raycast image in which shade is normally expressed.

The processor 140 visualizes a statistical value of voxel values in an arbitrary range on the virtual ray in the volume rendering by MIP, MinIP, AVE (average value method), or SUM methods. The statistical value is, for example, a maximum value, a minimum value, an average value, or a sum value. The statistical value is not affected by a calculation order of the voxel values of the voxels. Thus, the voxels present on the surface and the voxels of the internal portion are treated as equivalent voxels, and thus the voxels are appropriate for the internal visualization. Unlike a raycast method in which the statistical value is affected by a calculation order, an anteroposterior relation is not expressed in the depth direction of the voxels in the volume rendering by MIP, MinIP, AVE, SUM methods, or the like. This can be also said as “a method of mutually exchanging a positional relation when two or more voxels are used using voxel values of one or more voxels on the virtual ray, in determining the pixel value.” Accordingly, even when anteroposterior conversion is performed on the volume data on the virtual line (that is, anterior and posterior voxels are interchanged), the same result can be obtained and the same volume rendering image can be obtained. The arbitrary range on the virtual ray may be the entire volume data or may be a range in which the volume data interests a ROI.

In the foregoing embodiment, for example, the processor 140 performs maximum value combination using the MIP image. However, maximum value combination with the shading image may be performed using an SUM image or another volume rendering image other than the MIP image.

In the foregoing embodiment, a ROI in which a volume rendering image is generated may be the entire volume data including a subject or may be a part including a subject in the volume data.

In the foregoing embodiment, for example, the processor 140 is subjected to shading of a surface by surface rendering, but a surface may be shaded by another method. For example, the processor 140 may perform a shading process by raycasting. In this case, to derive shade of a contour on a surface, the processor 140 may calculate a gradient of a voxel value of each voxel with reference to a voxel to which a virtual my is projected and voxels in the periphery of this voxel. The voxels in the periphery of the voxel are, for example, eight voxels adjacent to one voxel in a 3-dimensional space. The processor 140 may generate a shading image of a contour indicated by a surface according to the gradient. The processor 140 may calculate the gradients from 64 voxels of 4×4×4 in the periphery of a voxel to which a virtual ray is projected. A surface normal which is also used for shade calculation can be acquired from the gradients. Thus, it is possible to obtain shade generated according to the raycast method. In this case, calculation is performed at a high speed when a threshold of voxel values of voxels desired to be visualized to be used in the raycast method is changed.

In the foregoing embodiment, for example, the processor 140 generates the shade using the gradients of the voxel values. Here, one of shade generated from the contour of a ROI and shade directly generated from the volume data or a combination of the shades can be considered as the generated shade. The shade directly generated from the volume data is a boundary surface obtained by partitioning the volume data with a certain threshold in some cases.

The processor 140 may adjust the volume data through various filtering processes and generate a boundary surface. A ROI can be obtained through a so-called segmentation process, but the processor 140 may generate a boundary surface obtained by partitioning the volume data with a certain threshold in the range within the ROI and obtain shade using the boundary surface.

In the foregoing embodiment, for example, the processor 140 generates the polygon mesh from the voxel data of the volume data as the contour of the subject in accordance with the marching cube method and acquires the surface of the tissue or the like from the polygon mesh. However, the surface may be acquired in accordance with another method.

For example, the processor 140 may generate a metaball using a target voxel as a seed point and use the surface. The processor 140 may process the acquired surface. In this case, for example, polygon reduction may be used. The processor 140 may smooth a surface shape. Thus, shade with small bump which is noise can be obtained from the surface directly generated from the volume data. The processor 140 may acquire a surface by combining the contour of a ROI and the contour generated in accordance with the marching cube method as the contour of a subject. Referring to the volume data in the boundary of a ROI, the processor 140 may acquire a surface with a so-called sub-voxel precision like the marching cube method in regard to the contour of the ROI.

In the foregoing embodiment, a region in which an internal image (for example, an MIP image) of a tissue or the like is generated may be the same as a region in which shading is performed on the contour of the tissue of the like. For example, in the liver 10 illustrated in FIG. 4, the region of the liver 10 in which the MIP image is generated is the same as the region of the liver 10 in which the shading image is generated.

In the foregoing embodiment, a region in which an internal image of a tissue or the like is generated may be different from a region in which shading is added on the contour of the tissue of the like. For example, in FIG. 8, the region in which the SUM image including the main artery 24 is generated is different from the region of the main artery 24 to which the shade of the contour of the main artery 24 is added. In FIG. 8, the region in which the SUM image is generated is larger than the region in which the shade is added. Thus, the user can easily ascertain the contour or sense of depth in a specific ROI inside the SUM image.

In the foregoing embodiment, the processor 140 may shade the contour expressed in the entire volume data rather than a specific region of the interest.

In the foregoing embodiment, the processor 140 may generate an internal image in regard to the entire volume data rather than a specific ROI.

In the foregoing embodiment, the processor 140 may set ON and OFF of culling (hidden surface processing). When the culling is set to be ON, the processor 140 determines whether the contour indicated on the surface faces in an eye direction or in a depth direction and renders the contour of only a portion facing in the eye direction. The processor 140) can also render the contour of only a portion in which a surface normal faces in the eye direction. When the culling is set to be OFF, the processor 140 does not perform the hidden surface processing and renders the contour regardless of whether the contour indicated on the surface faces in the eye direction or in the depth direction. The facing in the eye direction indicates facing in a forward direction of the virtual ray. The facing in the depth direction indicates facing in the depth direction of the virtual ray.

That is, when the culling is set to be ON, only a surface facing in the eye direction is expressed and a surface facing in the depth direction is omitted. When the culling is set to be OFF, a plurality of surfaces are all displayed. Accordingly, when the culling is set to be ON, the medical image processing apparatus 100 can suggest the contour which is more intuitive from the eye, and thus a synthetic image can be easily viewed. When the culling is set to be OFF, the medical image processing apparatus 100 can suggest a plurality of contours, and thus expression precision of the surfaces can be improved.

In the foregoing embodiment, the processor 140 allows points indicating a contour on only the frontmost surface side to remain and erases one or more points indicating a contour on the rear surface side. Even when a plurality of points indicating the contour is on the same virtual ray, both points indicating the contours on the front surface side and the rear surface side may be expressed. The points indicating the contour are, for example, points intersecting the surface.

In the foregoing embodiment, when a plurality of points indicting a contour are on the same virtual ray, the processor 140 may give a different color to each point. That is, the processor 140 may generate shade by causing the color of the contour on the front surface side and the color of the contour on the rear surface side to be different from each other.

In the foregoing embodiment, the processor 140 may change a region to which the shade of the contour is added by a predetermined setting or an instruction via the UI 120.

In the foregoing embodiment, the processor 140 may adjust luminance of the shade of the contour. When the luminance is adjusted, for example, a window width (WW) or a window level (WL) is operated via the UI 120 and the shade of the contour of which the luminance is adjusted is displayed on the display 130.

In the foregoing embodiment, the processor 140 may adjust luminance of a volume rendering image. When the luminance is adjusted, for example, a window width (WW) or a window level (WL) is operated via the UI 120 and the volume rendering image of which the luminance is adjusted is displayed on the display 130.

The processor 140 may adjust the luminance independently or commonly between a region of the contour of a tissue or the like and a region of an internal portion of the tissue or the like. When the luminance is adjusted using the WW/WL transformation function in the second operation example illustrated in FIG. 7, the luminance is adjusted commonly between the region of the contour of the tissue or the like and the region of the internal portion of the tissue or the like.

In the foregoing embodiment, for example, the processor 140 performs the maximum value combination of the shading image of the contour and the volume rendering image indicating the internal portion of the tissue or the like. However, the shading image and the volume rendering image may be combined in accordance with other combination methods. The other combination methods may include multiplication combination, minimum value combination, screen combination, and the like. The screen combination is calculated in accordance with, for example, (Equation 6) below.

Screen combination result=(superimposition color*(1−original color))+(original color*1) (Equation 6)

The “original color” is color of a combination source to be combined and indicates, for example, pixel values of RGB of an MIP image indicating an internal portion of a tissue or the like. The “superimposition color” is color of a combination destination to be combined and indicates, for example, pixel values of RGB of a shading image indicating the external shape of a tissue or the like. The combination source and the combination destination may be reversed. In addition, any combination mechanism may be used.

In the foregoing embodiment, the processor 140 may invert pixel values of one of a volume rendering image indicating an internal portion of a tissue or the like and a shading image of the contour, and then combine both the volume rendering image and the shading image. When the pixel values are inverted, light and shade of the image is inverted. This inversion process is effective when particularly an SUM image is included. This is because the image obtained by inverting the SUM image is similar to an image obtained by angiography. By obtaining an image inverted from the SUM image, a user is familiar with the image, and thus can easily observe the image.

In the foregoing embodiment, for example, the processor 140 generates each of the internal image and the shading image and then combines the internal image and the shading image. In the foregoing embodiment, for example, the processor 140 collectively generates the internal information and the shading information in units of pixels of an image and generates an image. The internal information and the shading information may be consequently included in the image to be consequently output, and the internal information and the shading information may be combined at any step of the calculation by the processor 140.

In the foregoing embodiment, various projection methods can be applied. The projection methods may include a parallel projection method, a perspective projection method, and a cylindrical projection method.

In the foregoing embodiment, the processor 140 may extract a region related to volume rendering indicating an internal portion of a tissue or the like and a region of which a contour is shaded from volume data and then perform various processes, or may perform the various processes without extracting these regions from the volume data.

In the foregoing embodiment, for example, the volume data which is the acquired CT image is transmitted from the CT apparatus 200 to the medical image processing apparatus 100. Instead, the volume data may be, transmitted to a server or the like on a network in order to be temporarily accumulated, and stored in the server or the like. In this case, the port 110 of the medical image processing apparatus 100 may acquire the volume data from the server or the like via a wired line or a wireless line or may acquire the volume data via any storage medium (not illustrated).

In the foregoing embodiment, for example, the volume data which is the acquired CT image is transmitted from the CT apparatus 200 to the medical image processing apparatus 100 via the port 110. This example is assumed to also include a case in which the CT apparatus 200 and the medical image processing apparatus 100 are substantially treated together as one product. This example also includes a case in which the medical image processing apparatus 100 is used as a console of the CT apparatus 200.

In the foregoing embodiment, for example, an image is acquired by the CT apparatus 200 and the volume data including information regarding an internal portion of an organism is generated. However, an image may be acquired by other apparatuses and volume data may be generated. The other apparatuses include a magnetic resonance imaging (MRI) apparatus, a positron emission tomography (PET) apparatus, an angiography apparatus, and other modality apparatuses. The apparatus may be used in combination with a plurality of modality apparatuses. A plurality of pieces of volume data obtained from the plurality of modality apparatuses may be combined. When the plurality of pieces of volume data obtained from the plurality of modality apparatuses are combined, a so-called registration process may be performed.

In the foregoing embodiment, the processor 140 uses the voxels included in the volume data. However, the voxels may include interpolated voxels.

In the foregoing embodiment, a human body is exemplified as an organism which is an example of a subject, but an animal body may be used.

The present disclosure can also be expressed as a medical image processing method in which an operation of the medical image processing apparatus is defined. Further, the present disclosure can also be applied to a program that realizes a function of the medical image processing apparatus according to the foregoing embodiment and is supplied to the medical image processing apparatus via a network or various storage media so that a computer in the medical image processing apparatus can read and execute the program.

### (Overview of Embodiment of the Present Disclosure)

In this way, the medical image processing apparatus 100 includes: the port 110 configured to acquire volume data including a subject; the processor 140 configured to generate a display image based on the volume data; and the display 130 configured to display the display image. A pixel value of at least one pixel of the display image is decided based on a statistical value of voxel values of voxels in an arbitrary range on a virtual ray projected to the volume data and shading of a contour of the subject at an arbitrary position on the virtual ray.

The statistical value of the voxel values may be a statistical value (MIP value) obtained by the MIP method or a statistical value (a sum value of the voxels) obtained by the SUM method. The shading of the contour may be a pixel value indicating shade of the contour obtained through surface rendering or the like. The display image may be any of the synthetic images G13 to G15.

Thus, the medical image processing apparatus 100 can express the state of the internal portion of the subject using the statistical value of the voxel values and can express the contour of the subject using the shading. Accordingly, the medical image processing apparatus 100 can improve visibility of both the state of the internal portion of the subject and the external shape of the subject. Accordingly, the user can observe the internal portion of the subject in detail and can clearly recognize the contour of the subject and obtain sense of depth and sense of bumps.

The medical image processing apparatus 100 may further include the UI 120 configured to receive designation of a ROI indicating the subject. The arbitrary position may be located on the boundary of the ROI.

Thus, the medical image processing apparatus 100 can add the shade to the boundary of the ROI, that is, the contour and thus can make it possible to easily ascertain the external shape of the subject.

The arbitrary range may be within the ROI. Thus, the medical image processing apparatus 100 can express the state of the internal portion of the ROI and can express the contour of the ROI. Accordingly, the medical image processing apparatus 100 can make it possible to easily ascertain the state of the internal portion and the external shape of a specific subject (for example, the liver 10).

The UI 120 may receive designation of a first ROI and a second ROI indicating the subject. The arbitrary range may be within the first ROI. The arbitrary position may be located on the boundary of the second ROI. The second ROI may be enclosed in the first ROI.

Thus, the medical image processing apparatus 100 can make it possible to easily ascertain the state of the internal portion of a specific subject (for example, an upper limb) and the external shape of another specific subject (for example, a main artery).

The processor 140 may generate surface data from the volume data and derive shade of the contour through surface rendering on the surface data.

Thus, the medical image processing apparatus 100 can ensure continuity of the surface as necessary compared to a case in which the surface normal of the contour is generated from gradient of a voxel of the volume data and can also process the surface. Accordingly, since the shade is added to the surface indicating the contour clearly, the user can ascertain the contour of the subject more clearly.

The processor 140 may derive the statistical value of the voxel values of the voxels in the arbitrary range on the virtual ray based on the MIP method, the MinIP method, the average value method, or the SUM method.

Thus, the medical image processing apparatus 100 can easily acquire the volume rendering image indicating the internal portion of the subject using a general derivation method.

The processor 140 may perform luminance transformation based on the statistical value of the voxel values and derive the pixel value of the display image.

Thus, the medical image processing apparatus 100 can derive luminance appropriate for display based on the statistical value of the voxel values of the pixels and display the display image. In particular, when the internal portion of the subject is indicated by the SUM image, the statistical value of the voxel values (voxel sum value) tends to increase.

However, the medical image processing apparatus 100 can perform transformation to luminance appropriate for the display so that the display image can be easily viewed.

The display image may be formed so that the statistical value of the voxel values and the shade on the virtual ray value are separable through invertible transformation on the display image.

Thus, the medical image processing apparatus 100 can directly separate the shading information indicating the external shape of the subject and the internal information indicating the internal portion of the subject from the display image, and thus can recall the shading image and the internal image. Accordingly, the medical image processing apparatus 100 can make it possible to easily ascertain a relation between the internal portion and the contour of the subject even in a shape in which a region of the internal portion of the subject and a region of the contour of the subject are complicatedly overlapped.

The pixel value of each pixel of the display image may be a value obtained through maximum value combination of the statistical value of the voxel values and the shading on the virtual ray.

Thus, the medical image processing apparatus 100 can mainly express the internal portion of the subject in a portion in which the internal information of the subject is dominant and can mainly express the shade of the contour of the subject in a portion in which the shading information of the subject is dominant. Accordingly, the medical image processing apparatus 100 can prevent appearance of the shade in which fine priority is low. The medical image processing apparatus 100 can prevent appearance of the shade having a low priority.

The arbitrary position at which the contour is obtained may be included in the arbitrary range in which the statistical value is acquired.

Thus, the medical image processing apparatus 100 can express the state of the internal portion of the subject using the statistical value of the voxel values and can express the contour present on the surface or the internal side of the subject using the shading. Further, the position at which the shading is acquired is included in the range in which the statistical value is acquired. Accordingly, the medical image processing apparatus 100 can improve visibility of both the state of light and shade of the internal portion of the subject and the external and internal shapes of the subject. Accordingly, the user can observe the internal portion of the subject in detail and can clearly recognize the contour of the subject and obtain sense of depth and sense of bumps.

The present disclosure is useful for a medical image processing apparatus, a medical image processing method, and a medical image processing program capable of improving visibility of both an internal state of a subject and an external shape of the subject.

What is claimed is:

1. A medical image processing apparatus comprising:
a port that acquires volume data including a subject;
a processor that generates an image based on the volume data; and
a display that displays the generated image,
wherein a pixel value of at least one pixel of the image is defined based on (i) a statistical value of voxel values of voxels in a predetermined range on a virtual ray projected to the volume data and (ii) shading of a contour of the subject at a predetermined position on the virtual ray.

2. The medical image processing apparatus according to claim 1, further comprising:
a user interface that receives designation of a region of interest indicating the subject,
wherein the predetermined position is located on the boundary of the region of interest.

3. The medical image processing apparatus according to claim 2,
wherein the predetermined range is within the region of interest.

4. The medical image processing apparatus according to claim 1, further comprising:
a user interface that receives designation of a first region of interest and a second region of interest indicating the subject,
wherein the predetermined range is within in the first region of interest,
the predetermined position is located on the boundary of the second region of interest, and
the second region of interest is enclosed in the first region of interest.

5. The medical image processing apparatus according to claim 1,
wherein the processor generates surface data from the volume data and derives shading of the contour through surface rendering on the surface data.

6. The medical image processing apparatus according to claim 1,
wherein the processor derives the statistical value based on an MIP method, a MinIP method, an average value method, or an SUM method.

7. The medical image processing apparatus according to claim 1,
wherein the processor performs luminance transformation based on the statistical value of the voxel values and derives the pixel value of the image.

8. The medical image processing apparatus according to claim 1,
wherein the image is formed such that the statistical value of the voxel values on the virtual ray and the shading are separable through invertible transformation on the image.

9. The medical image processing apparatus according to claim 1,
wherein the pixel value of each pixel of the image is a value obtained through maximum value combination of the statistical value of the voxel values on the virtual ray and the shading.

10. The medical image processing apparatus according to claim 1,
wherein the predetermined position is within the predetermined range.

11. A medical image processing method in a medical image processing apparatus, the method comprising:
acquiring volume data including a subject;
generating an image based on the volume data; and
displaying the generated image,
wherein a pixel value of at least one pixel of the image is defined based on (i) a statistical value of voxel values of voxels in a predetermined range on a virtual ray projected to the volume data and (ii) shading of a contour of the subject at a predetermined position on the virtual ray.

12. A medical image processing system causing a medical image processing apparatus to execute operations comprising:
acquiring volume data including a subject;
generating an image based on the volume data; and
displaying the generated image,
wherein a pixel value of at least one pixel of the image is defined based on (i) a statistical value of voxel values of voxels in a predetermined range on a virtual ray projected to the volume data and (ii) shading of a contour of the subject at a predetermined position on the virtual ray.
